(19) United States
(12) Patent Application Publication
(10) Pub. No.: US 2008/0143499 A1
(43) Pub. Date: Jun. 19, 2008

(54) SECURITY DEVICE AND METHOD

(75) Inventor: Toshio SHIMOMURA, Chiryu-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/952,784

(22) Filed: Dec. 7, 2007

(30) Foreign Application Priority Data
Dec. 15, 2006 (JP) 2006-339218

(51) Int. Cl. B60R 25/10; E05B 45/06

(52) U.S. Cl. 340/426.28; 340/542

(57) ABSTRACT

A security device for a vehicle having doors that can be locked and unlocked by using a mechanical key or an electronic portable unit, which transmits a signal of door unlock instruction. When the doors are unlocked, a monitoring state is reset and an alarm is unset, and it is checked if the doors are unlocked by using the mechanical key or by using the signal transmitted from the portable unit. If it is determined that the doors are unlocked by using the mechanical key, the user is informed of this fact.

### CROSS REFERENCE TO RELATED ALLOCATION

This application is based on and incorporates herein by reference Japanese Patent Application No. 2006-339218 filed on Dec. 15, 2006.

### FIELD OF THE INVENTION

This invention relates to a security device and method for an object to be secured having an opening/closing mechanism that can be locked and unlocked by any of a mechanical key and a portable unit that transmits a signal.

### BACKGROUND OF THE INVENTION

As a security device, JP 2000-85535A proposes a burglar alarm device for a vehicle that produces an alarm upon detecting a vehicle thieving attempt. This burglar alarm device for a vehicle shifts into a non-alarming standby state on condition that a door is unlocked by a keyless entry system when a driver is going to use a vehicle. When doors are all closed and are locked by the keyless entry system, on the other hand, the burglar alarm device shifts into an alarming standby state where the states of the doors are monitored to produce an alarm in case an abnormal condition is detected such as when the door is forcibly opened.

It is also likely that a mechanical key is used instead of the keyless entry system. That is, the burglar alarm device shifts into the non-alarming standby state on condition that the doors are unlocked by using the mechanical key, and shifts into the alarming standby state on condition that the doors are all closed and the doors are locked by using the mechanical key.

In the case of using the mechanical key, however, if the mechanical key is forged or made as a fake, the door can be easily unlocked and shifts into the non-alarming standby state. That is, if the door is unlocked by using the forged mechanical key, the object to be secured is no longer monitored for its abnormal condition and the security performance decreases.

### SUMMARY OF THE INVENTION

It is therefore an abject of the present invention to provide a security device and method capable of maintaining the security performance without being lowered.

According to the present invention, in a security device and method for a vehicle having a door that is locked and unlocked by a mechanical key or an electronic portable unit for transmitting a signal of door lock/unlock instruction, a monitoring state is set for monitoring abnormal condition of the vehicle after the door is locked. It is checked if the door is unlocked by the mechanical key or the portable unit in the monitoring state. A signal is transmitted to an external side away from the vehicle to indicate door unlocking in response to a check result indicating that the door is unlocked by the mechanical key.

Preferably, a predetermined operation on the vehicle, which includes at least one of opening a hood of the vehicle and removing a battery of the vehicle, is checked. The signal is transmitted only when the predetermined operation is detected. A voltage of the battery is detected at time of the predetermined operation. The signal is transmitted only when the voltage of the battery is over a predetermined value.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram schematically illustrating a security device according to a first embodiment of the invention;

FIG. 2 is a flowchart illustrating a processing operation of the security device according to the first embodiment of the invention;

FIG. 3 is a flowchart illustrating a processing operation of the security device according to a second embodiment of the invention;

FIG. 4 is a block diagram schematically illustrating the security device according to a third embodiment of the invention;

FIG. 5 is a flowchart illustrating a processing operation of the security device according to the third embodiment of the invention;

FIG. 6 is a flowchart illustrating a processing operation of the security device according to a fourth embodiment of the invention;

FIG. 7 is a flowchart illustrating a processing operation of the security device according to a fifth embodiment of the invention;

FIG. 8 is a flowchart illustrating a processing operation of the security device according to a sixth embodiment of the invention; and

FIG. 9 is a flowchart illustrating a processing operation of the security device according to a seventh embodiment of the invention.

### DESCRIPTION OF THE PREFERRED EMBODIMENTS

### First Embodiment

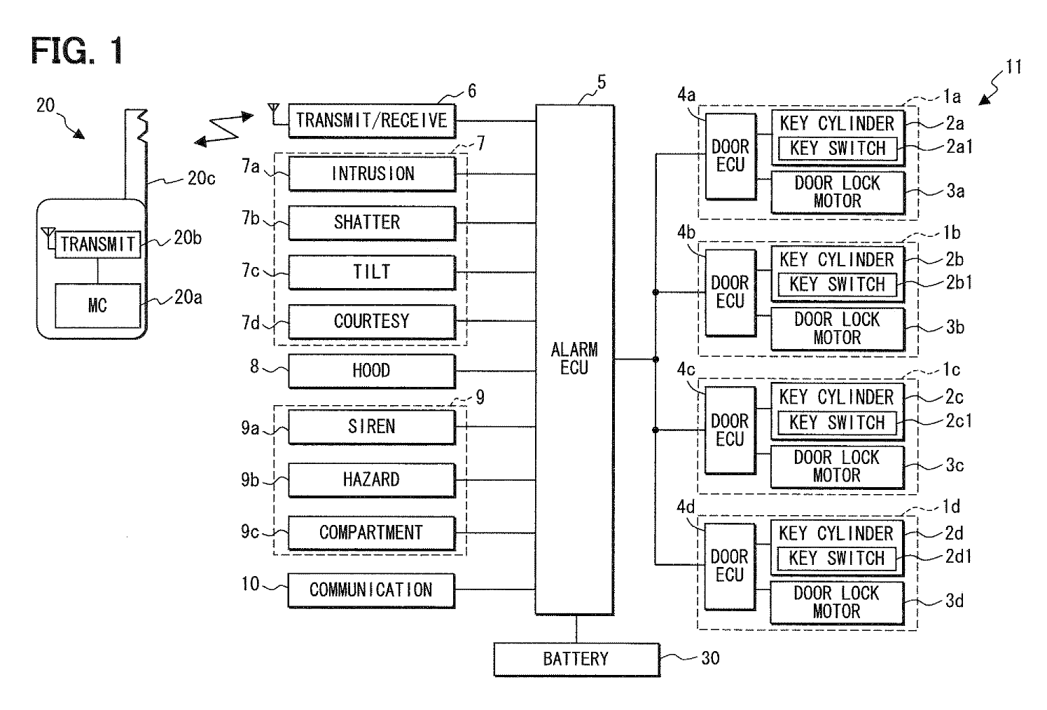

Referring to FIG. 1, a security device 11 is constructed for use in a vehicle. The security device 11 includes key cylinders 2a to 2d in which a mechanical key 20c will be inserted to unlock respective vehicle doors 1a to 1d, key switches 2a1 to 2d1 provided in the key cylinders 2a to 2d, door electronic control units (ECUs) 4a to 4d electrically connected to the key switches 2a1 to 2d1, and door lock motors 3a to 3d electrically connected to the door ECUs 4a to 4d in the vehicle doors (opening/closing mechanisms) 1a to 1d of the vehicle (object to be secured). The security device 11 further includes an alarm ECU 5 electrically connected to the door ECUs 4a to 4d, a transmitter/receiver 6 electrically connected to the alarm ECU 5, a burglar detector 7, a hood sensor 8, an alarm 9 and a communication ECU 10.

The vehicle doors 1a to 1d can be locked and unlocked by using an electronic portable unit 20 (wireless key) carried by a vehicle user. The portable unit 20 includes a microcomputer 20a, a transmitter 20b, a mechanical key 20c and an electric cell (not shown). Further, the portable unit 20 has its mechanical key 20c, which can be inserted in the key cylinders 2a to 2d, and the mechanical key 20c is turned so as to lock or unlock the vehicle doors 1a to 1d. Further, upon operating a door locking button or a door unlocking button (not shown) provided in the portable unit 20, a locking signal or an unlocking signal is transmitted to the transmitter/receiver 6 from the transmitter 20b based upon an instruction from the microcomputer 20a, and the vehicle doors 1a to 1d can be locked or unlocked. The locking signal or the unlocking signal is output to the transmitter/receiver 6 from the portable unit 20, and is sent to the door ECUs 4a to 4d via the alarm ECU 5. The mechanical key 20c may be separated from the portable unit 20.

The key switches 2a1 to 2d1 of the security device 11 are for detecting if the vehicle doors 1a to 1d are to be locked or unlocked depending upon the direction (clockwise or counter-clockwise) in which the mechanical key 20c is turned. The key switches 2a1 to 2d1 send, to the door ECUs 4a to 4d, signals indicating if the vehicle doors 1a to 1d are locked or unlocked by the mechanical key 20c.

Responsive to signals from the transmitter/receiver 6 (alarm ECU 5) and signals from the key switches 2a1 to 2d1, the door ECUs 4a to 4d in the security device 11 drive the door lock motors 3a to 3d to effect the locking or unlocking. Further the door ECUs 4a to 4d send signals to the alarm ECU 5 to indicate that the vehicle doors 1a to 1d are locked or unlocked by the signal transmitted from the portable unit 20 or to indicate that the vehicle doors 1a to 1d are locked or unlocked by using the mechanical key 20c.

The alarm ECU 5 may be a microcomputer that includes CPU, ROM and RAM, and peripheral circuits. Based upon the signals from the door ECUs 4a to 4d, the alarm ECU 5 checks if the vehicle doors 1a to 1d are locked or unlocked by the signal transmitted from the portable unit 20, or the vehicle doors 1a to 1d are locked or unlocked by using the mechanical key 20c. The alarm ECU 5 further checks if the monitoring state should be set to monitor the abnormal condition of the vehicle (thieving attempt) based on a result detected by the burglar detector 7 that will be described later, or the monitoring state should be reset. In the monitoring state, an alarming standby state (alarm set) is set to produce an alarm by the alarm 9 if abnormal condition is detected by the burglar detector 7. To reset the monitoring state, the alarming standby state is reset (alarm unset).

The burglar detector 7 operates as abnormal condition detector means or burglar detector means, and includes an intrusion sensor 7a, a glass shatter sensor 7b, a tilt sensor 7c, a door courtesy sensor 7d and the like. The intrusion sensor 7a detects a person who intrudes into the vehicle based on infrared-ray detection or ultrasonic wave detection, and sends a detection signal to the alarm ECU 5 when the intrusion is detected. The glass shatter sensor 7b detects the shattering of glass by picking up the sound of when a window glass is broken, using a microphone or an ultrasonic sensor, and sends a detection signal to the alarm ECU 5 when the shattering is detected. The tilt sensor 7c detects a change in the electrostatic capacity (electric signal) between a fixed electrode and a moving electrode that moves depending on the angle of the vehicle that is tilted, and sends a detection signal inclusive of a tilt angle to the alarm ECU 5. The door courtesy sensor 7d detects the vehicle doors 1a to 1d when they are opened or closed, and sends a detection signal to the alarm ECU 5 when the vehicle doors 1a to 1d are opened by using a duplicate key or are forcibly opened. The intrusion sensor 7a, glass shatter sensor 7b, tilt sensor 7c and door courtesy sensor 7d are installed at suitable places in the vehicle. The burglar detector 7 is not limited to the above sensors only, as a matter of course.

The hood sensor 8 detects the hood that is opened and sends a signal indicating the opened hood to the alarm ECU 5. The hood sensor 8 does not have to be necessarily used in this embodiment.

The alarm 9 operates as alarm means, and includes a siren 9a, a hazard lamp 9b and a compartment lamp 9c. When a thieving attempt is made, the siren 9a, hazard lamp 9b and room lamp 9c produce alarming sound, turns on or flashes the lamp based on an instruction from the alarm ECU 5. It is desired that the siren 9a, hazard lamp 9b and room lamp 9c incorporate batteries to continuously produce alarm even in case a storage battery 30 is removed. The alarm 9 is not limited to the siren 9a, hazard lamp 9b and room lamp 9c only.

Based on an instruction from the alarm ECU 5, the communication ECU 10 informs the user of the fact that the vehicle doors 1a to 1d are unlocked by using the mechanical key 20c. That is, the communication ECU 10 transmits a signal indicating that the vehicle doors 1a to 1d are unlocked by using the mechanical key 20c. The communication ECU 10 includes a control unit constructed by, for example, a CPU, a ROM, a RAM and an I/O bus, and a communication unit which is so constructed as to make a communication with an external unit (e.g., user's portable unit (cell phone, etc.) or user's personal computer) in a state where the communication can be made (in a normally operating state within a communicable range). To inform the user of the fact that the vehicle doors 1a to 1d are unlocked by using the mechanical key 20c, a voice, an indicator or characters may be output from the user's portable terminal or personal computer based on a signal transmitted from the communication ECU 10.

In addition to transmitting the signal from the communication ECU 10 to the user's portable terminal or personal computer, the signal transmitted from the communication ECU 10 may be once received by a service station (not shown), and the user may be informed of the signal from the service station.

The portable unit 20 and the communication ECU 10 may be so constructed that the communication is made directly between the portable unit 20 and the communication ECU 10. That is, when the vehicle doors 1a to 1d are unlocked by using the mechanical key 20c, the communication ECU 10 may transmit to the portable unit 20 a signal indicating that the vehicle doors 1a to 1d are unlocked by using the mechanical key 20c, while the portable unit 20 may be so constructed as to output the above signal to inform the user of the fact that the vehicle doors 1a to 1d are unlocked by using the mechanical key 20c.

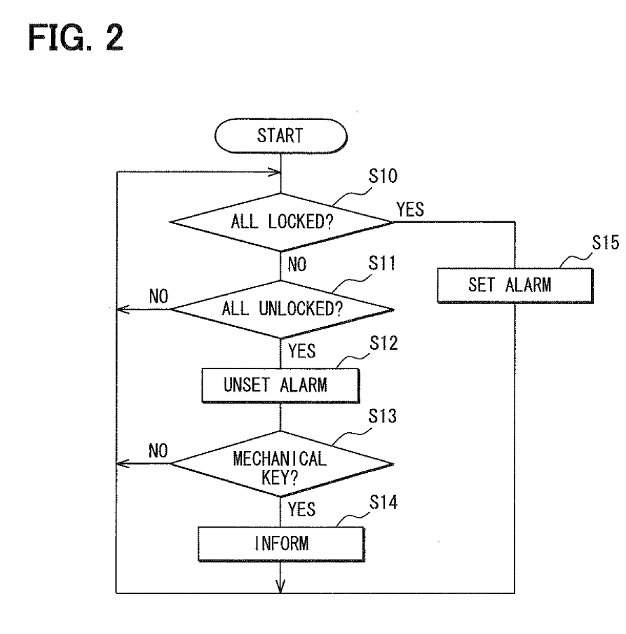

The security device 11, particularly the alarm ECU 5, is programmed to execute the processing operation as shown in FIG. 2, which is repeated at regular time intervals.

At step (S) 10, the alarm ECU 5 checks if the vehicle doors 1a to 1d (all doors) are locked based on the signals from the door ECUs 4a to 4M. If it is determined that all the doors are locked, the routine proceeds to S15. If it is not determined that all the doors are locked, the routine proceeds to S11. If it is determined at S10 that the vehicle doors 1a to 1d are locked, the alarm ECU 15 sets the alarm at S15, and the routine returns to S10. That is, the alarm ECU 5 sets a monitoring state for monitoring the abnormal condition of the vehicle (thieving attempt) based on the result detected by the burglar detector 7, and sets an alarming standby state so that the alarm 9 produces an alarm if the abnormal condition is detected by the burglar detector 7. Thus, the alarm ECU 5 operates as setting means.

On the other hand, if it is not determined at S10 that the vehicle doors 1a to 1d have been locked, the alarm ECU 5 checks at S11 if the vehicle doors 1a to 1d are unlocked based on the signals from the door ECUs 4a to 4d. If it is determined that all the vehicle doors are unlocked, the routine proceeds to S12. If it is not determined that all the vehicle doors are unlocked, the routine returns to S10.

At S12, the alarm ECU 5 unsets the alarm and the routine proceeds to S13. That is, the alarm ECU 5 resets the monitoring state for monitoring the abnormal condition of the vehicle (thieving attempt), which is made based on the result detected by the burglar detector 7. If the abnormal condition is detected by the burglar detector 7, the alarm ECU 5 resets the alarming standby state in which the alarm 9 produces an alarm.

At S13, the alarm ECU 15 checks if the vehicle doors 1a to 1d are unlocked by using the wireless key or are unlocked by using the mechanical key 20c based on the signals from the door ECUs 4a to 4d. That is, the alarm ECU 15 checks if the vehicle doors 1a to 1d are unlocked by the signal transmitted from the portable unit 20 or the vehicle doors 1a to 1d are unlocked by using the mechanical key 20c. If it is determined that the vehicle doors 1a to 1d are unlocked by using the mechanical key 20c, the routine proceeds to S14. If it is determined that the vehicle doors 1a to 1d are unlocked by using the signal transmitted from the portable unit 20, the routine returns to S10.

At S14, the alarm ECU 5 informs the user of the fact that the vehicle doors 1a to 1d are unlocked by using the mechanical key 20c through the communication ECU 10.

As described above, when the vehicle doors 1a to 1d are unlocked by using the mechanical key 20c, the user is informed of this fact even in case the vehicle doors 1a to 1d are unlocked by using a fake mechanical key and the monitoring state is reset, suppressing a decrease in the security performance.

Though the above embodiment has described a case where the security device of the invention was applied to the vehicle, it should be noted that the invention is not limited thereto only and can be further applied to, for example, houses or buildings.

### Second Embodiment

A security device according to the second embodiment is constructed in the same manner as that of the first embodiment. The second embodiment is different from the above first embodiment with respect to informing the user also of the opening of the hood.

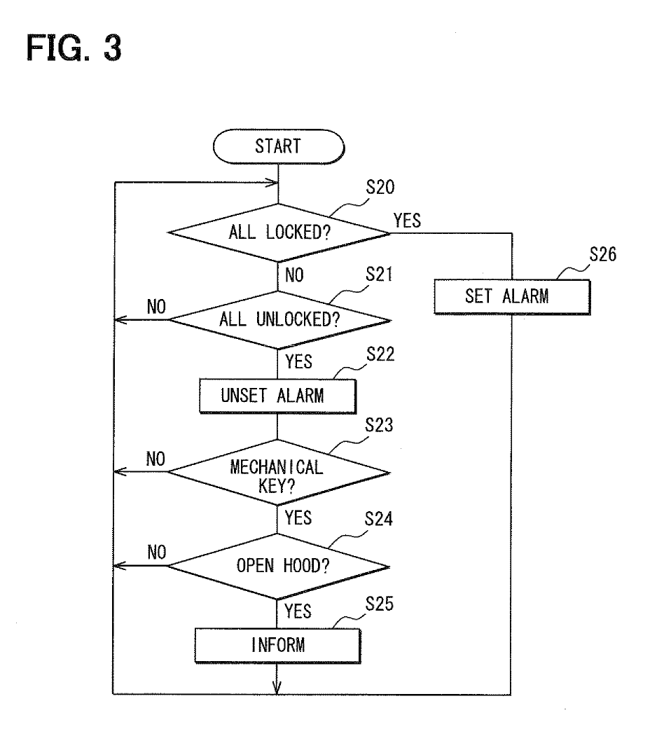

The processing operation of the security device of this embodiment will now be described with reference to FIG. 3. S20, S21, S22, S23, S25 and S26 of FIG. 3 is the same as S10, S11, S12, S13, S14 and S15 of FIG. 2, respectively. The processing of FIG. 3 is repeated at regular time intervals.

In the state where all the doors are unlocked by using the mechanical key (determined at 523 that the mechanical key is used), the alarm ECU 5 checks if the hood is opened based on a result detected by the hood sensor 8. If the alarm ECU 5 has determined that the hood is opened, the routine proceeds to S25 and the user is informed of that the vehicle doors 1a to 1d are unlocked by using the mechanical key through the communication ECU 10 at S25. If the alarm ECU 5 has not determined that the hood is opened, the user is not informed of anything and the routine returns to S20.

If the mechanical key 20c is a fake, not genuine, and used to unlock the vehicle doors 1a to 1d and reset the monitoring state, it may often be attempted to open the hood in order to once remove the battery 30. Therefore, if the vehicle doors 1a to 1d are unlocked by using the mechanical key and the hood is opened, the user is informed of this fact, i.e., the user is informed of that the vehicle doors 1a to 1d are unlocked by using the mechanical key and that the monitoring state is reset. This operation does not lower the security performance.

According to this embodiment, further, it is checked if the hood is opened to determine the probability in that the vehicle doors 1a to 1d are unlocked by using the fake mechanical key. If the probability is high, then the user is informed of this fact. That is, if the vehicle doors 1a to 1d are unlocked by using the mechanical key and the hood is opened, it is so regarded that the probability is high, and the user is informed of this fact. Therefore, unnecessary notice can be decreased as compared to when the user is always informed of that the vehicle doors 1a to 1d are simply unlocked by using the mechanical key 20c.

### Third Embodiment

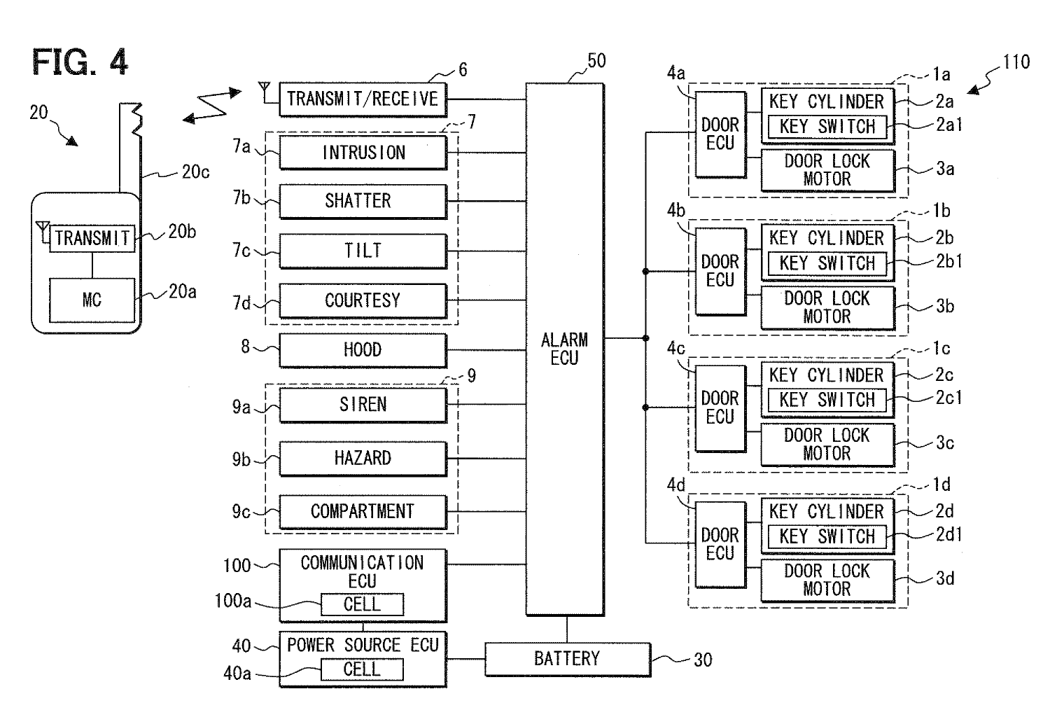

A security device according to a third embodiment is constructed as shown in FIG. 4. A security device 110 of the third embodiment is similar to the first embodiment but different from the first embodiment with respect to informing the user also of a removal of a battery. The security device 110 thus further includes an alarm ECU 50, a communication ECU 100 operated by a built-in battery cell 100a, and a power source ECU 40 operated by a built-in battery cell 40a.

The alarm ECU 50 sends, to a communication ECU 100, a signal which indicates that the vehicle doors 1a to 1d are locked or unlocked by using a signal transmitted from the portable unit 20 or indicates that the vehicle doors 1a to 1d are locked or unlocked by using the mechanical key 20c. At the time of setting the monitoring state, resetting the monitoring state, setting the alarm or unsetting the alarm, the alarm ECU 50 sends, to the communication ECU 100, a signal which indicates that the monitoring state is set, the monitoring state is reset, the alarm is set or the alarm is unset. The alarm ECU 50 may send, to the communication ECU 100, a signal which indicates that the hood is opened as detected by the hood sensor 8.

The power source ECU 40 is constructed by, for example, a CPU, ROM, RAM and I/O bus, and operates to detect if the battery 30 is removed, to detect the voltage of the battery 30 and to store the voltage in a storage unit (not shown). In this embodiment, the object is achieved if the power source ECU 40 is capable of detecting the removal of the battery 30. The power source ECU 40 sends, to the communication ECU 100, the detected result of if the battery 30 is removed and the voltage of the battery 30.

Based upon the signals from the alarm ECU 50 and the power source ECU 40, the communication ECU 100 checks if the user be informed. If it is determined that the user be informed, then the user is informed of.

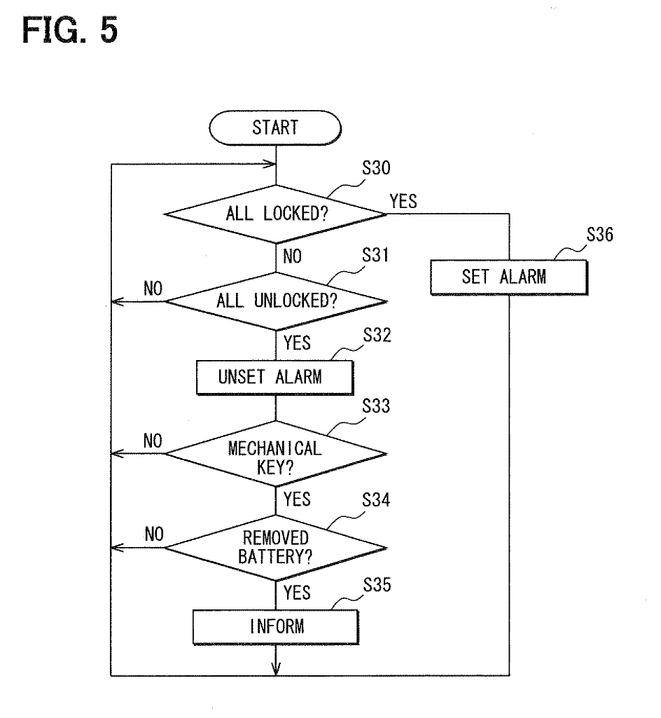

The processing operation of the security device 110 is shown in FIG. 5. S30, S31, S32, S33, S35 and S36 of FIG. 5 is the same as S10, S11, S12 S13 S14 and S15 of FIG. 2, respectively. The processing of FIG. 5 is repeated at regular time intervals.

In a state where the alarm is unset (S32), the communication ECU 100 checks, based on a signal from the alarm ECU 50, if the doors are unlocked by using the wireless key or are unlocked by using the mechanical key 20c. That is, the communication ECU 100 is output through the alarm ECU 50, and checks if the vehicle doors 1a to 1d are locked or unlocked by using a signal transmitted from the portable unit 20, or the vehicle doors 1a to 1d are locked or unlocked by using the mechanical key 20c. If it is determined that the vehicle doors 1a to 1d are unlocked by using the mechanical key 20c, the routine proceeds to S34. If it is determined that the vehicle doors 1a to 1d are unlocked by using the signal transmitted from the portable unit 20, the routine returns to S30.

At S34, the communication ECU 100 checks if the battery 30 has been removed based on a signal from the power ECU 40 in order to check if the user be informed of that the vehicle doors 1a to 1d are unlocked by using the mechanical key 20c. If the communication ECU 100 does not determine that the battery 30 has been removed, the user is not informed of, and the routine returns to S30. If it is determined that the battery 30 has been removed, the routine proceeds to S35. At S35, the communication ECU 100 informs the user of the fact that the vehicle doors 1a to 1d are unlocked by using the mechanical key.

If the mechanical key 20c is a fake one, the vehicle doors 1a to 1d are unlocked, and the monitoring state is reset, it may often be attempted to open the hood and to once remove the battery 30. Therefore, if the vehicle doors 1a to 1d are unlocked by using the mechanical key 20c and the battery 30 is removed, the user is informed of this fact, i.e., the user is informed of that the vehicle doors 1a to 1d are unlocked by using the mechanical key 20c and that the monitoring state is reset, thus maintaining the security performance. Further, unnecessary notice can be decreased as compared to when the user is always informed of that the vehicle doors 1a to 1d are simply unlocked by using the mechanical key 20c.

### Fourth Embodiment

A security device according to a fourth embodiment is constructed the same as that of the third embodiment, and is different from the third embodiment with respect to informing the user also of the battery voltage.

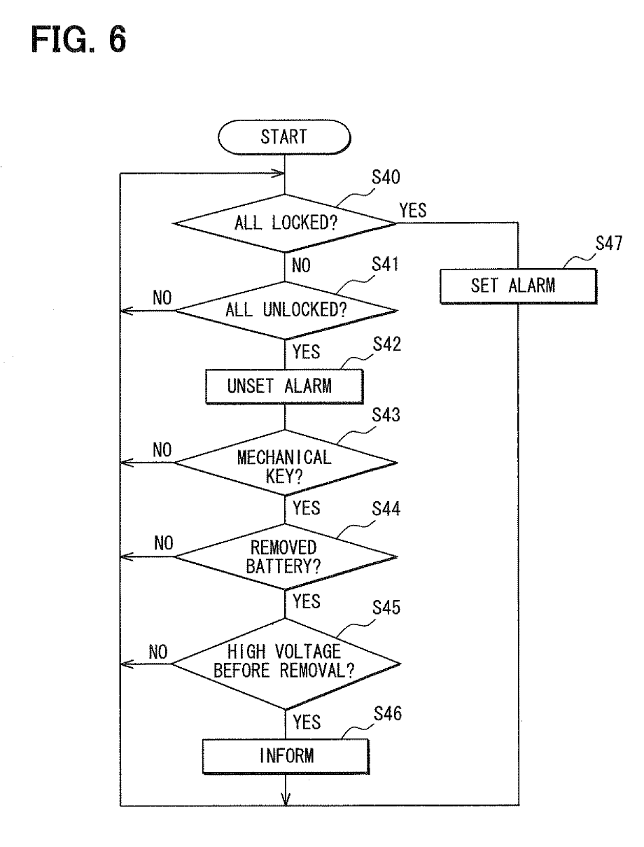

The processing operation of the security device 110 according to this embodiment is shown in FIG. 6. S40, 541, S42, S43, S44, S46 and S47 of FIG. 6 are the same as 530, S31, S32, 533, S34, S35, S36 of FIG. 5, respectively. The processing of FIG. 6 is repeated at regular time intervals.

At S45 following the determination that the battery 30 has been removed (YES at S44), the communication ECU 100 checks, based on a signal representing a voltage of the battery 30 output from the power source ECU 40, if the voltage of the battery 30 of before being removed is higher than a predetermined value in order to determine if the user be informed of that the vehicle doors 1a to 1d are unlocked by using the mechanical key 20c.

That is, the communication ECU 100 checks if the voltage of the battery 30 of just before the power source ECU 40 has output a signal indicating the removal of the battery 30 is higher than a predetermined value. If it is determined that the voltage of the battery 30 before being removed is less than the predetermined value, it is so regarded that the battery 30 is replaced by the user. In this instance, the user is not informed of the removal, and the routine returns to S40. If it is determined that the voltage of the battery 30 before being removed is higher than the predetermined value, it is so regarded that the battery 30 is removed under abnormal condition (thieving attempt) of the vehicle, and the routine proceeds to S46.

Usually, the hood is opened to replace the battery 30. Therefore, if the voltage of the battery 30 before being removed is not over the predetermined value, the user is informed of nothing. If the voltage of the battery 30 before being removed is higher than the predetermined value, the user is informed of this fact to further decrease unnecessary notice. That is, if the voltage of the battery 30 before being removed is not over the predetermined value, it is so regarded that the battery is replaced with a new one by the user, and the user is informed nothing.

At a moment when it is determined that the battery 30 is removed, the power source ECU 40 may output, to the communication ECU 100, a signal representing the voltage of the newest battery 30 stored in the storage unit.

### Fifth Embodiment

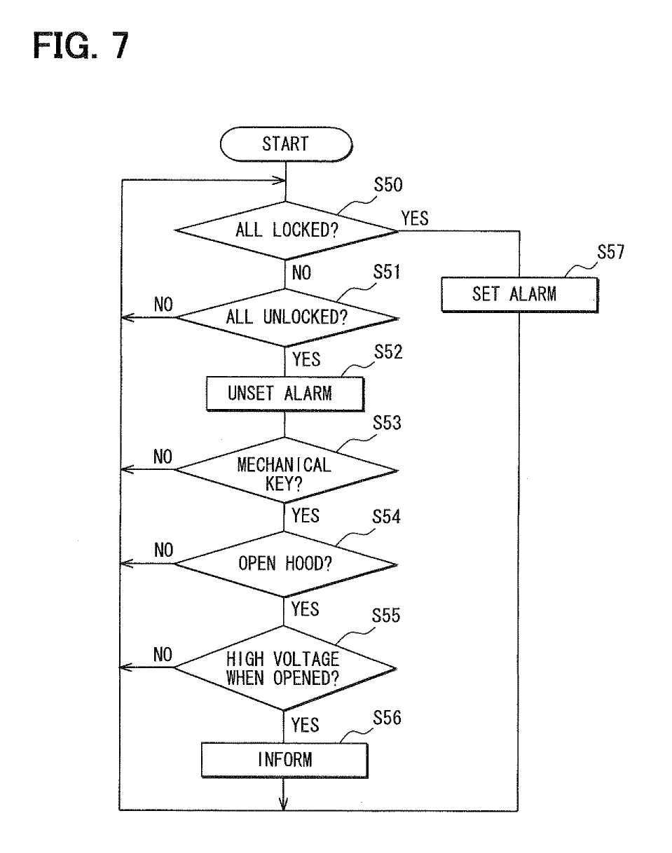

A security device according to a fifth embodiment is constructed the same as that of the above third embodiment, and executes the processing shown in FIG. 7. The fifth embodiment is different from the third and fourth embodiments with respect to informing the user also of the battery voltage at the time when the hood is opened.

S50, S51, S52, S53, S56 and S57 of FIG. 7 are the same as S30, S31, S32, S33, S35 and S36 of FIG. 5, respectively. The flow of FIG. 7 is repeated at regular time intervals.

At S54, which is executed in a state where the vehicle doors 1a to 1d are unlocked by using the mechanical key (YES at S53), the communication ECU 100 checks, based on a result detected by the hood sensor 8 output from the alarm ECU 50, if the hood is opened. If the communication ECU 100 determines that the hood is opened, the routine proceeds to S55. If the communication ECU 100 does not determine that the hood is opened, the user is not informed of anything, and the routine returns to S50.

At S55, the communication ECU 100 checks if the voltage of the battery 30 at the time when the hood is opened is higher than a predetermined value based on a signal representing the voltage of the battery 30 output from the power source ECU 40 in order to check if the user be informed of that the vehicle doors 1a to 1d are unlocked by using the mechanical key 20c. That is, the communication ECU 100 checks if the voltage of the battery 30 is higher than the predetermined value at the time when the signal is output from the alarm ECU 50 indicating that the hood is opened. If it is determined that the voltage of the battery 30 at the time when the hood is opened is less than the predetermined value, it is so regarded that the hood is opened by the user to replace the battery 30, and the user is informed of nothing, and the routine returns to S50. If it is determined that the voltage of the battery 30 at the time when the hood is opened is higher than the predetermined value, it is so regarded that the hood is opened under abnormal condition (thieving attempt) of the vehicle, and the routine proceeds to S56.

As described above, if the voltage of the battery 30 at a moment when the hood is opened is not over the predetermined value, opening the hood can be so regarded that the battery is renewed, and the user is informed of nothing. If the voltage of the battery 30 at a moment when the hood is opened is higher than the predetermined value, the user is informed of this fact, further decreasing unnecessary notice.

### Sixth Embodiment

A security device of a sixth embodiment is constructed the same as that of the above third embodiment, and is different from the third to fifth embodiments with respect to informing the user also of the opening of the hood and the removal of the battery.

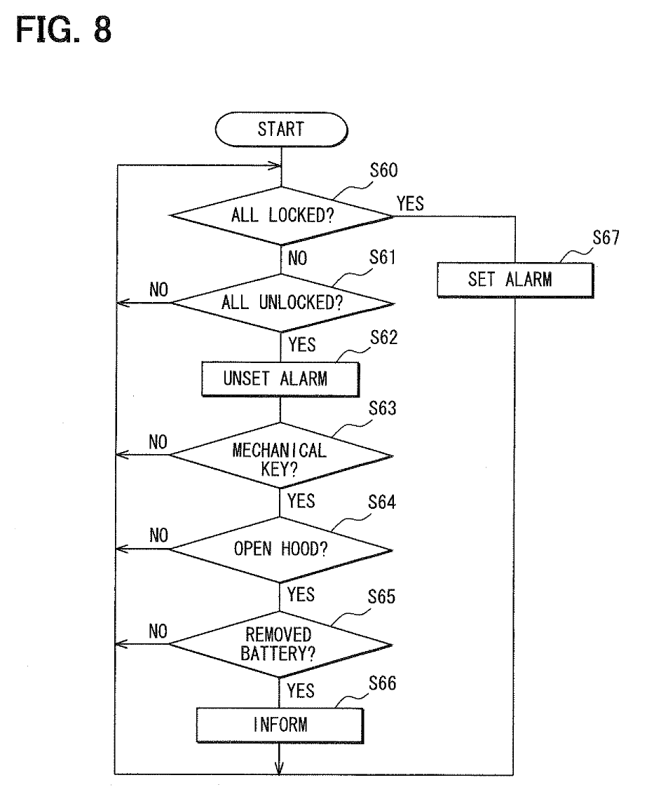

S60, S61, S62, S63, S64, 566 and S67 of FIG. 8 are the same as S50, S51, S52, S53, S54, 556 and S57 of FIG. 7. The processing of FIG. 8 is repeated at regular time intervals.

At S65 executed in a state where the hood is opened (YES at S64), the communication ECU 100 checks, based on a signal from the power source ECU 40, if the battery 30 is removed. The ECU 100 checks if the user be informed of that the vehicle doors 1a to 1d are unlocked by using the mechanical key 20c. If the communication ECU 100 does not determine that the battery 30 is removed, the user is informed of nothing, and the routine returns to S60. If the communication ECU 100 determines that the battery 30 is removed, the routine proceeds to 566.

This makes it possible to decrease unnecessary notice as compared to when the user is informed of in case the vehicle doors 1a to 1d are unlocked by using the mechanical key 20c and the hood is opened.

### Seventh Embodiment

A security device according to a seventh embodiment is constructed the same as the third embodiment. The seventh embodiment is different from the above third to sixth embodiments with respect to informing the user also of the opening of the hood, the removal of the battery and the voltage of the battery.

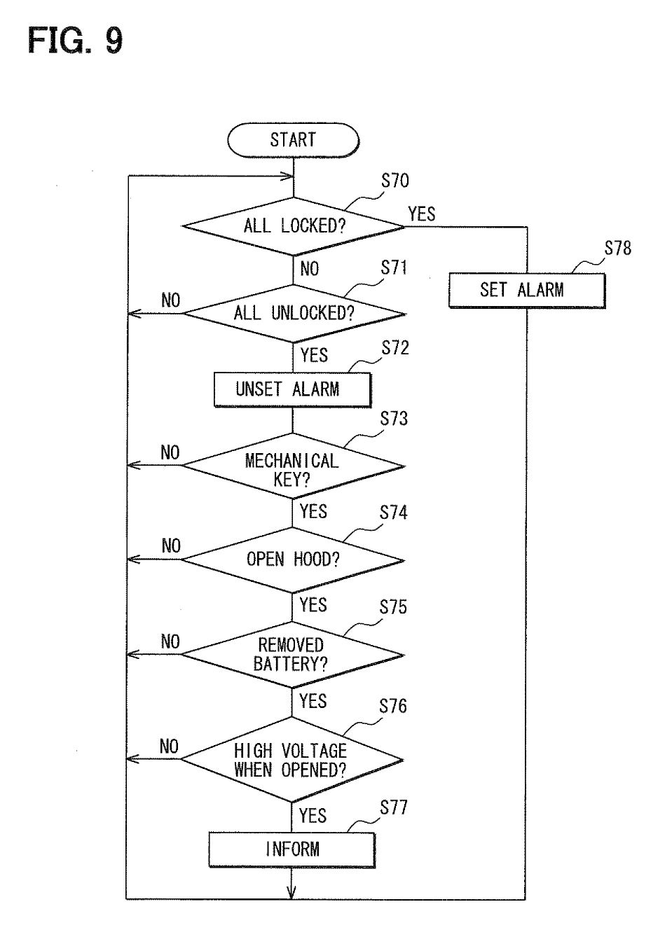

S70, S71, S72, S73, S74, S75, S77 and S78 of FIG. 9 are the same as 560, S61, S62, S63, S64, S65, 566 and S67 of FIG. 8, respectively. The processing FIG. 9 is repeated at regular time intervals.

At S76 executed in a state where the battery 30 is removed (YES at S75), the communication ECU 100 checks, based on a signal representing the voltage of the battery 30 output from the power source ECU 40, if the voltage of the battery 30 at a moment when the hood is opened is higher than a predetermined value. The communication ECU 40 checks if the user be informed of that the vehicle doors 1a to 1d are unlocked by using the mechanical key 20c. That is, the communication ECU 100 checks if the voltage of the battery 30 is higher than the predetermined value at a moment when a signal representing the opening of the hood is output from the alarm ECU 50. If it is determined that the voltage of the battery 30 at a moment when the hood is opened is not over the predetermined value, then it is so regarded that the hood is opened by the user to replace the battery 30, and the user is informed of nothing, and the routine returns to S70. If it is determined that the voltage of the battery 30 at the moment when the hood is opened is higher than the predetermined value, it is so regarded that the hood is opened under abnormal condition (thieving attempt) of the vehicle, and the routine proceeds to S77.

Here, instead of checking if the voltage of the battery 30 when the hood is opened is higher than the predetermined value, it is also allowable to check if the voltage of the battery 30 before being removed is higher than the predetermined value. In this case, if it is determined that the voltage of the battery 30 before being removed is not over the predetermined value, the user is informed of nothing, and the routine returns to S70. If it is determined that the voltage of the battery 30 before being removed is higher than the predetermined value, it is so regarded that the hood is opened under abnormal condition (thieving attempt) of the vehicle, and the routine proceeds to S77.

Usually, the battery is often replaced by opening the hood. Therefore, if the voltage of the battery 30 is less than the predetermined value at the moment when the hood is opened, the user is informed of nothing. On the other hand, if the voltage of the battery 30 is higher than the predetermined value at the moment when the hood is opened, the user is informed of this fact, further decreasing unnecessary notice. That is, if the voltage of the battery at the moment when the hood is opened is not over the predetermined value, it is so regarded that the battery is replaced, and the user is informed of nothing.

Though the above embodiments are examples in which a wireless key is used as the portable unit 20, it should be noted that the invention is in no way limited thereto only. For example, the portable unit may be a smart entry key or the like. In this case, the vehicle is equipped with a switch operated by the user and a communication unit which transmits a request signal to the portable unit. In response to the request signal, the portable unit transmits a response signal. The vehicle doors are locked when the response signal is transmitted from the portable unit and the switch is operated. The alarm ECU does not set the alarming standby state when the response signal is transmitted from the portable unit and the switch is operated in a state where the vehicle doors have been locked by using the mechanical key.

1. A security device for an object to be secured having an opening/closing mechanism that is locked and unlocked by a mechanical key or an electronic portable unit for transmitting a signal of door lock/unlock instruction, the security device comprising:
abnormal condition detector means for detecting abnormal condition of the object to be secured;
setting means for setting a monitoring state for monitoring abnormal condition of the object to be secured based on a result detected by the abnormal condition detector means when the opening/closing mechanism is locked, and for resetting the monitoring state when the opening/closing mechanism is unlocked;
check means for checking if the opening/closing mechanism is locked or unlocked by the mechanical key or the portable unit; and
informing means that informs a user of an indication of unlocking of the opening/closing mechanism, when the opening/closing mechanism is unlocked by the mechanical key.

2. The security device according to claim 1, wherein the informing means is provided with communication means capable of making a wireless communication with an external device.

3. The security device according to claim 1, wherein the object to be secured is a vehicle, and the opening/closing mechanism is a door of the vehicle.

4. The security device according to claim 1, further comprising:
alarming means for generating alarm,
wherein the setting means causes the alarming means to generate alarm if the abnormal condition is detected by the abnormal condition detector means in the monitoring state.

5. The security device according to claim 1, wherein the abnormal condition detector means includes burglar detector means for detecting an attempt for thieving the vehicle.

6. A security device which operates with power supplied from a battery and is used for a vehicle having a door that is locked and unlocked by a mechanical key or an electronic portable unit for transmitting a signal of door lock/unlock instruction, the security device comprising:
abnormal condition detector means for detecting abnormal condition of the vehicle;
a hood sensor for detecting opening of a hood of the vehicle;
setting means for setting a monitoring state for monitoring abnormal condition of the vehicle based on a result detected by the abnormal condition detector means when the door is locked, and for resetting the monitoring state when the door is unlocked;
check means for checking if the door is locked or unlocked by the mechanical key or the portable unit; and
informing means that informs a user of the vehicle of an indication of door unlocking, when the door is unlocked by the mechanical key and the hood is opened.

7. The security device according to claim 6, further comprising:
battery detector means which is powered by a built-in cell and detects if a battery is removed,
wherein the informing means is powered by a built-in cell, and informs the user of no indication when the battery detector means detects no removal of the battery.

8. The security device according to claim 7, further comprising:
voltage detector means for detecting a voltage of a battery; and
storage means for storing the voltage detected by the voltage detector means,
wherein the informing means informs the user of no indication when the voltage of the battery at a moment when the hood is opened is less than a predetermined value, and informs the user of the indication when the voltage of the battery is over the predetermined value.

9. The security device according to claim 6, further comprising:
voltage detector means for detecting a voltage of a battery; and
storage means for storing the voltage detected by the voltage detector means,
wherein the informing means informs the user of no indication when the voltage of the battery at a moment when the hood is opened is less than a predetermined value, and informs the user of the indication when the voltage of the battery is over the predetermined value.

10. A security device which operates with power supplied from a battery and is used for a vehicle having a door that is locked and unlocked by a mechanical key or an electronic portable unit for transmitting a signal of door lock/unlock instruction, the security device comprising:
abnormal condition detector means for detecting abnormal condition of the vehicle;
setting means for setting a monitoring state for monitoring abnormal condition of the vehicle based on a result detected by the abnormal condition detector means when the door is locked, and for resetting the monitoring state when the door is unlocked;
check means for checking if the door is locked or unlocked by the mechanical key or the portable unit;
battery detector means which is powered by a built-in cell and detects if the battery is removed; and
informing means which is powered by a built-in cell and informs a user of an indication of door unlocking, when the door is unlocked by the mechanical key and the battery is removed.

11. The security device according to claim 10, further comprising:
voltage detector means for detecting a voltage of a battery; and
storage means for storing the voltage detected by the voltage detector means,
wherein the informing means is powered by a built-in cell, and informs no indication when the voltage of the battery before being removed is less than a predetermined value, and informs the indication when the voltage of the battery is over the predetermined value.

12. A security method for a vehicle having a door that is locked and unlocked by a mechanical key or an electronic portable unit for transmitting a signal of door lock/unlock instruction, the security method comprising:
setting a monitoring state for monitoring abnormal condition of the vehicle after the door is locked;
checking if the door is unlocked by the mechanical key or the portable unit in the monitoring state; and
transmitting a signal to an external side away from the vehicle to indicate door unlocking in response to a check result indicating that the door is unlocked by the mechanical key.

13. The security method according to claim 12, further comprising:
detecting a predetermined operation on the vehicle including at least one of opening a hood of the vehicle and removing a battery of the vehicle,
wherein the transmitting step transmits the signal only when the predetermined operation is detected.

14. The security method according to claim 12, further comprising:
detecting a voltage of the battery at time of the predetermined operation,
wherein the transmitting step transmits the signal only when the voltage of the battery is over a predetermined value.
